(19) United States
(12) Patent Application Publication
(10) Pub. No.: US 2011/0289216 A1
(43) Pub. Date: Nov. 24, 2011

(54) System and Method for Generating Subnets and Using Such Subnets for Controlling Access to Web Content

(76) Inventors: Timothy Szeto, Markham (CA); John William Madden, Markham (CA)

(21) Appl. No.: 13/112,861

(22) Filed: May 20, 2011

Related U.S. Application Data
(60) Provisional application No. 61/347,162, filed on May 21, 2010.

(51) Int. Cl. G06F 15/173

(52) U.S. Cl. 709/225

(57) ABSTRACT

A system and a method are provided for generating a subnet and using the subnet to control access to web content. An Open Subnet (OSN) server is provided to receive proposed web pages to be added to a white list on the subnet, as well as votes from one or more users whether or not to add one or more of the web pages to the white list. A sync server is connected to the OSN through an intermediary. The sync server obtains a copy of the white list and, based on a user's license to the subnet, a user is allowed access to web pages on the white list.

### CROSS-REFERENCE TO RELATED APPLICATIONS

The present application claims priority to U.S. Patent Application No. 61/347,162 filed May 21, 2010 hereby incorporated by reference in its entirety.

### TECHNICAL FIELD

The following relates generally to subnets and more particularly for generating subnets and using such subnets for controlling access to web content.

### BACKGROUND

The world-wide-web (WWW) and other information and data available via the Internet is known to contain both useful and appropriate content and non-useful and/or inappropriate content. For example, some web pages may contain material that is deemed to be inappropriate for minors, such as pornography or graphic violence, and other web pages may be deemed frivolous and thus inappropriate when accessed in the workplace environment during working hours.

Various mechanisms have been employed in an attempt to control access to the varied content available through the WWW. For example, Internet sites or particular web pages can be blacklisted, i.e. “forbidden” and using an appropriate software tool, access to such web pages can be blocked. One problem with blacklisting is that new web pages are being added continuously or changing locations or domains and thus keeping an up-to-date blacklist is typically quite onerous. Accordingly, despite the effort involved in blocking some web pages, users can still find newer content that is equally inappropriate but as yet not blacklisted.

Web pages can also be white listed, i.e. deemed “acceptable” such that only those sites on the white list can be accessed. One problem with white listing is that it can be difficult to determine what is appropriate such that once it is added to the list, its appropriateness, is implied. As such, white lists tend to evolve slowly thus blocking content that should be acceptable but is not yet on the white list thus creating a frustrating experience for the user.

It is an object of the following to address the above disadvantages.

### SUMMARY

A system and a method are provided for generating a list of domains and using the subnet to control access to web content. In one aspect, an open subnet server is provided to receive one or more proposed web pages to be added to a white list on the list of domains, as well to receive one or more votes from one or more users. The one or more votes are in regards to determining whether or not to add one or more of the web pages to the white list. A sync server is also provided in connection to the open subnet server. The sync server obtains a copy of the white list and, based on an end user's license to the list of domains, provides to the end user access to web pages on the white list.

### BRIEF DESCRIPTION OF THE DRAWINGS

Embodiments will now be described by way of example only with reference to the appended drawings wherein:

FIG. 1 is a block diagram illustrating a system for generating and controlling subnet lists.

FIG. 2 is a block diagram illustrating an example configuration for the system of FIG. 1.

FIG. 3 is block diagram illustrating an example configuration for the open subnet (OSN) of FIG. 2.

FIG. 4 is a chart illustrating an example mapping between user type and voting contributions.

FIG. 5 is a block diagram illustrating an example voting procedure implemented by the voting system of FIG. 1 for registered users.

FIG. 6 is a block diagram illustrating an example voting procedure implemented by the voting system of FIG. 1 for guest users.

FIG. 7 is a flow chart illustrating an example voting calculation.

FIG. 8 is a block diagram illustrating an example subnet search and voting process from the search results.

FIG. 9 is a block diagram illustrating an example subnet review page and voting process from the review page.

FIG. 10 is a block diagram illustrating an example configuration for the third party intermediary of FIG. 2.

FIG. 11 is a flow chart illustrating a hierarchy for searching in various example subnets.

FIG. 12 is a flow chart illustrating a user profile hierarchy under a license.

FIG. 13 is a block diagram illustrating an example configuration for a client service to communicate with an intermediary via the sync server of FIG. 2.

FIG. 14 is a block diagram illustrating an example configuration for the sync server of FIG. 2.

FIG. 15 is a flow diagram illustrating example computer executable instructions executed by the sync server for updating a copy of a white list.

FIG. 16 is a flow diagram illustrating example computer executable instructions executed by the sync server for blocking or approving a web page request and determining the validity of a licence to access a subnet.

FIG. 17 is a screen shot of an example graphical user interface (GUI) for the search engine of FIG. 3.

### DETAILED DESCRIPTION OF THE DRAWINGS

It has been found that providing a system and a method for generating subnets using a voting strategy allows for a collection of approved domains or web sites to grow more quickly. A voting strategy also allows for users of different rankings to have greater influence on the approved or rejected web content. The subnets can also be used to effectively control access to web content based on a user's profile, and their license to one or more subnets. In this way, the control of access to web content is more easily distributed and managed amongst many users. Furthermore, the combination of the voting strategy and the subnets allows the control of access to the web content to evolve over time based on the accumulation of users' opinions.

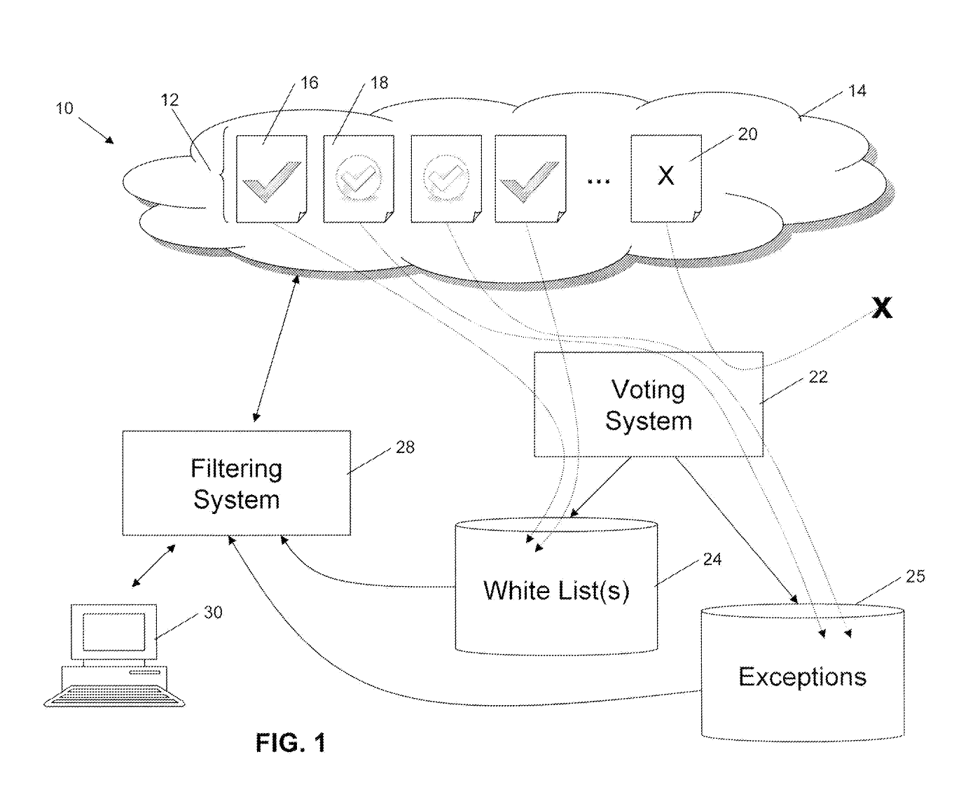

Turning now to FIG. 1, a system 10 is shown that enables content 12 available on the Internet 14 to be evaluated using a voting system 22 to generate subnets comprising one or more white lists 24 specifying white listed content 12, and to generate user-specific exceptions 25 defining content 12 that may be inside or outside a white list 24 but is still deemed unacceptable or acceptable to that particular user. The white lists 24 and exceptions 25 provide a way to determine the acceptability and/or appropriateness of particular content 12. By using the voting system 22, the white lists 24 and exceptions 25 can be built collaboratively and can provide a level of trust or credibility to content control. The system 10 also enables such white lists 24 and exceptions 25 to be used by a filtering system 28 to control a user's access to the Internet 14, e.g. via a personal computer (PC) 30, as shown, or other Internet-enabled device (not shown). Other examples of internet-enabled devices that can be used include mobile devices, tablets, laptops, personal digital assistants, cell phones and smart phones.

In the example shown in FIG. 1, the content 12 comprises one or more white-listed content items 16 (e.g. white listed web sites or pages), which are accessible to the PC 30 via the filtering system 28 on a subnet specific basis. The content 12 may also comprise one or more exception items 18, which are either deemed accessible or inaccessible to the PC 30 via the filtering system 28 on a user-specific basis. The content 12 may also comprise one or more blocked items 20, which are not part of a white list 24 or acceptable via an exception 25. It can be appreciated that the distinction between a blocked item 20 and an exception that blocks, an item regardless of its status with respect to the white lists 24 is only for illustrative purposes. For example, an item may be deemed a blocked item 20 with respect only to a particular white list 24 while being deemed acceptable in other white lists 24 and thus to those that have access to the subnets associated with such other white lists 24.

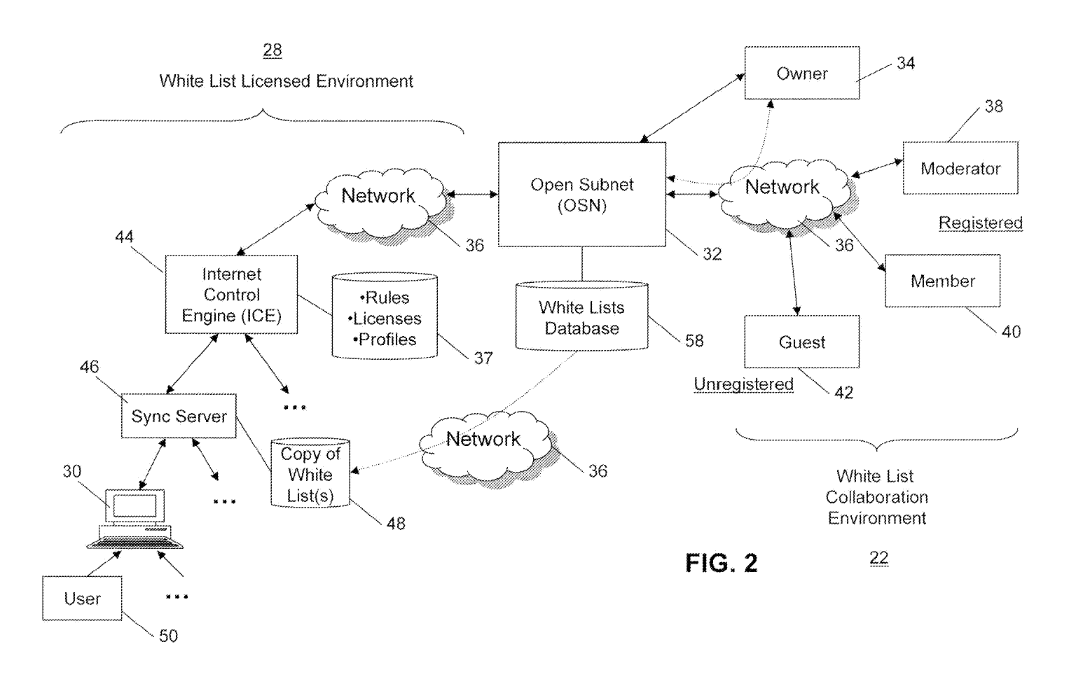

Turning now to FIG. 2, an example configuration for providing the voting system 22 and filtering system 28 is shown. In this configuration, a server, referred to herein as the Open Subnet (OSN) 32 is accessible via a network 36 (such as the Internet 14) by various entities in order to enable a white lists database 58 to be generated in a collaborative manner using the voting system 22. In the example shown, an owner 34 may access the OSN 32 either directly or via the network 36 and can control what content 12 is added to a particular white list 24. As will be explained in greater detail below, the owner 34 can be given a veto power or have their voting contributions heavily weighted when compared to other entities in order to give the owner 34 increased control over the voting procedure. For example, the owner 34 could represent a school administrator that controls the generation and evolution of a subnet for a particular school or school board and thus has the ability to ensure that certain content 12 is blocked or allowed.

As noted, the system 10 enables the white lists 24 to be created and to evolve in a collaborative manner in order to provide a level or trust and/or credibility to the subnet that is defined by the white lists 24. In order to encourage collaboration, the OSN 32 can allow both registered and unregistered users to contribute to the voting system 22. In this example, registered users include one or more moderators 38 and one or more members 40. It can be appreciated that more or fewer levels of granularity can be provided to distinguish between members in the hierarchy. For example, various member tiers can be used or master moderators chosen from groups of moderators, etc. This example illustrates unregistered users as being guests 42. This allows observers or other interested parties to contribute to the evolution of a white list 24 either to gain membership within the voting system 22, or to strengthen a white list's relevance, similar to a wiki type system. As will be explained in greater detail below, the voting system 22 enables various user roles to be defined with corresponding maximum contributions to favour those that are responsible for or more likely to utilize the white list 24.

The collaborative generation of white lists 24 enables the OSN 32 to provide the white lists 24 to the filtering system 28 in order to control access to the Internet 14 according to what is defined in the white lists 24 and any user-specific exceptions 25 that have been applied. The white lists 24 can therefore be provided via licenses such that one group or entity can be responsible for generating and evolving the white list 24 whilst others can benefit from the collaborative efforts inherent therein. The OSN 32 can thus provide an interface between the generation and maintenance of the white lists 24 and their use in a licensed environment.

The OSN 32 in this example is connectable to a third party intermediary 44 via the network 36. The intermediary 44 can be a server, engine or other device or entity that is capable of communicating over the network 36. The intermediary 44 maintains an internet control database 37 which may include rules, licenses, profiles, and other data and information that enables a user 50 to use the filtering system 28 according to one or more white lists 24. The intermediary 44 may also be referred to as an Internet Control Engine (ICE). It can be appreciated that the OSN 32 and intermediary 44 are shown as separate entities for illustrative purposes only and could instead be the same entity providing both collaboration and licensed use functionality. By separating the OSN 32 from the intermediary 44, other entities can access the OSN 32 in a manner similar to the intermediary 44 such that different organizations can license white lists 24 in different geographic or demographic areas or in different industries. For example, the intermediary 44 can be used to control Internet traffic in a school environment and a separate Internet security company can also connect to the OSN 32 to license white lists for providing consumer-based Internet security software and services. As such, the configuration shown in FIG. 2 can be modified or take different forms depending on the nature of the application and relationships between the OSN 32 and other entities.

To enable many users 50 in multiple locations to access the intermediary 44, one or more sync servers 46 can be used. The sync servers 46 have access to a white list database 48, which includes copies of the white listed content 12 that enables the sync server 46 to perform a comparison of a request/query from the PC 30 to a licensed white list 24 in order to block or allow content 12 to the user 50. The white list database 48 should be under the control of the OSN 32 such that the white list contents are not divulged.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the OSN 32, database 58, intermediary 44, sync server 46, database 48, PC 30, etc., or accessible or connectable thereto. Any application or module herein described may be implemented using computer readable/executable instructions that may be stored or otherwise held by such computer readable media.

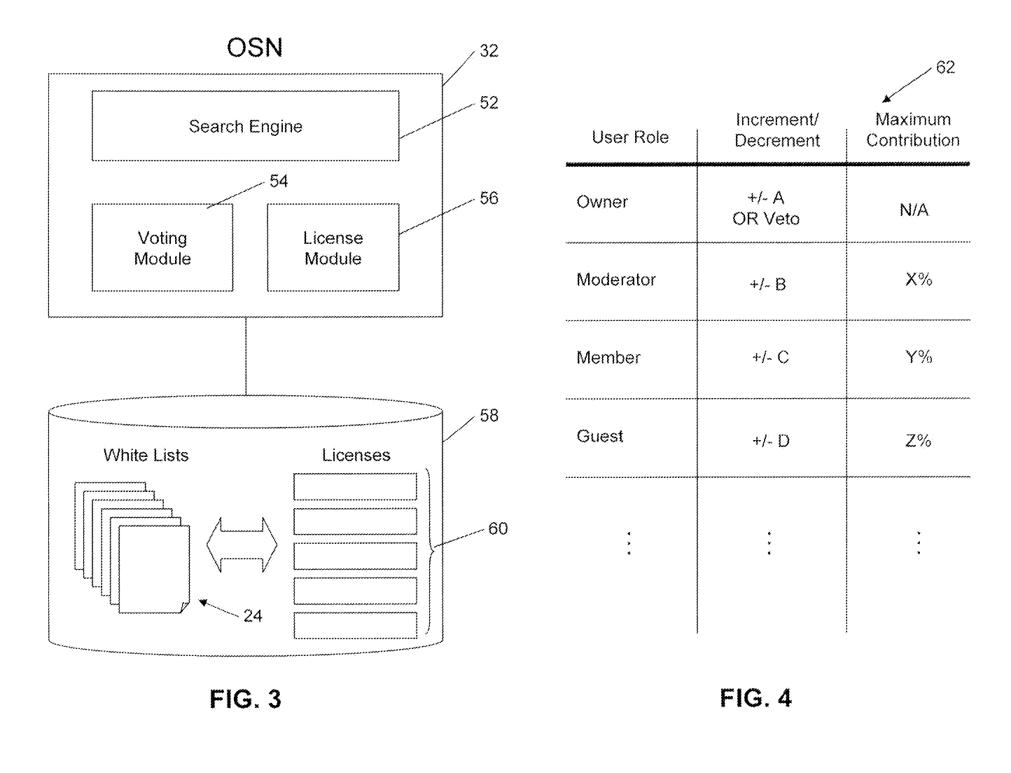

To enable collaboration, the OSN 32 provides web searching capabilities as a way in which to allow registered and non-registered users to vote on particular content 12. FIG. 3 shows an example configuration for the OSN 32. The OSN 32 comprises a search engine 52 or other web module that provides searching capabilities. The OSN 32 also comprises a voting module 54 to enable the voting system 22 to be integrated into or with the search engine 52. The OSN 32 also comprises a license module 56 to track licences that have been granted to intermediaries 44. The white lists database 58 is also shown in FIG. 3 and comprises a series of white lists 24 that have been generated and are evolving in the collaborative environment. The database 58 also comprises details of various licenses 60 and how they map to the various white lists 24. For example, one or more licences 60 may permit access to one or more than one white list 24 and may define the number of entities that may access a particular white list 24 under that license. In this way, the OSN 32 can control who and what has access to the valuable information contained in each white list 24.

To determine whether or not particular content 12 is added to a white list 24, and to evolve the contents of the white list 24, e.g. to move domains through from a “pending” to “approved” status, a voting scheme can be implemented in the voting system 22, an example of which is shown in FIG. 4. In the example voting scheme shown in FIG. 4, each user role (owner 34, moderator 38, member 40, guest 42 in this example) has associated therewith, an increment/decrement value, and a maximum contribution. The increment/decrement value indicates the number of points that are contributed to an overall score for each vote by that type of user. The maximum contribution value can be used to set, for example, a maximum percentage of the overall score that can come from that type of user. For example, to limit results being skewed by guests 42, a maximum of, for example, 30% can be imposed. It will be appreciated that the maximum contribution may or may not be a percentage of the total score. In the example scheme of FIG. 4, the owner 34 is not given a maximum contribution in order to allow the owner 34 to have dominating control over the score and/or veto power. The owner can thus being given a highest increment/decrement value (+/−A) or a discrete veto capability. The moderators 38, members 40, and guests 42 are then given increment/decrement values (B, C, D) that should diminish in value such that the guest 42 has the lowest contribution to the scoring. Similarly, declining maximum contributions (X, Y, Z) can be given to these entities in the order of the hierarchy.

To illustrate how the example scheme in FIG. 4 can be implemented, the following scenario assumes that a score of greater than 99 approves the content 12, a score of less than −99 blocks the content 12, and a score between −99 and 99 indicates a “pending” status. The pending status allows the content 12 to be evaluated over time and across many user-types to evolve the score through collaboration. In this way, the content 12 does not need to be scored and firmly evaluated right away but instead can be proposed and then voted on over time. This also allows the acceptability of content 12 to fluctuate over time such that even though the content 12 is approved now, if negative voting occurs in the future (e.g. if the content's appropriateness changes later), the content 12 can move back into the pending status or blocked status. To utilize the ranges above, one can assume that A=100, B=20, C=10, and D=1. Also, to control contributions from the different groups, X=80%, Y=60%, and Z=20%. In this way, moderators 38 can have a much greater influence over the score than guests 42 since, even if many guests 42 vote in a particular way, in order for the content 12 to be approved some contribution must come from other user types (assuming a 50% pass threshold).

Since A=100 in this example, if the owner 34 votes for a particular content item 12, it would be approved right away. Conversely, regardless of the score owing to the other user types (since the contributions can be capped), by voting against a particular content item 12, the −100 would ensure that the score remains in the pending or blocked categories. The owner 34 can promote other users to member 40 or moderator 38 status in order to give them more voting power. In this way, although the owner 34 has a powerful contribution to the voting score, if important users such as moderators 38 vote against a domain that was approved by the owner 34 or conversely vote for a domain that was denied by the owner 34, the overall score can overcome the owner's contribution. This allows the collaborative environment to offer a democratic voting scheme in order to ensure that domains are added to a white list 24 or blocked based on the collaborative efforts of various users rather than solely based on the owner's vote.

The search engine 52 enables users, e.g. members. 40 to find content 12 within a particular subnet defined by a white list 24 and any content 12 that is returned in a search query can be voted on. The content 12 that is returned has already been added to a white list 24 but can be further voted on to change its status, e.g. to change from “pending” to “approved” based on further collaborative contributions. In another example, the status of a domain can change over time from an “approved” status to a “pending” status or to a “denied” status, should the voting users (e.g. members 40, moderator 38, owner 34, guest 42) decide that domain is not appropriate for the subnet. This may be the case where, in an example scenario, a certain domain originally perceived to be appropriate, is later found to be unreliable or a distraction to users. Therefore, the approved status of the certain domain may diminish.

It is noted that the search engine 52 works differently based on whether it is in the collaborative environment 22 or the usage environment 28. In the usage environment 28, a user 50 can only see search results that are approved. Therefore, the user 50 does not see or is not able to view the pending or denied domains.

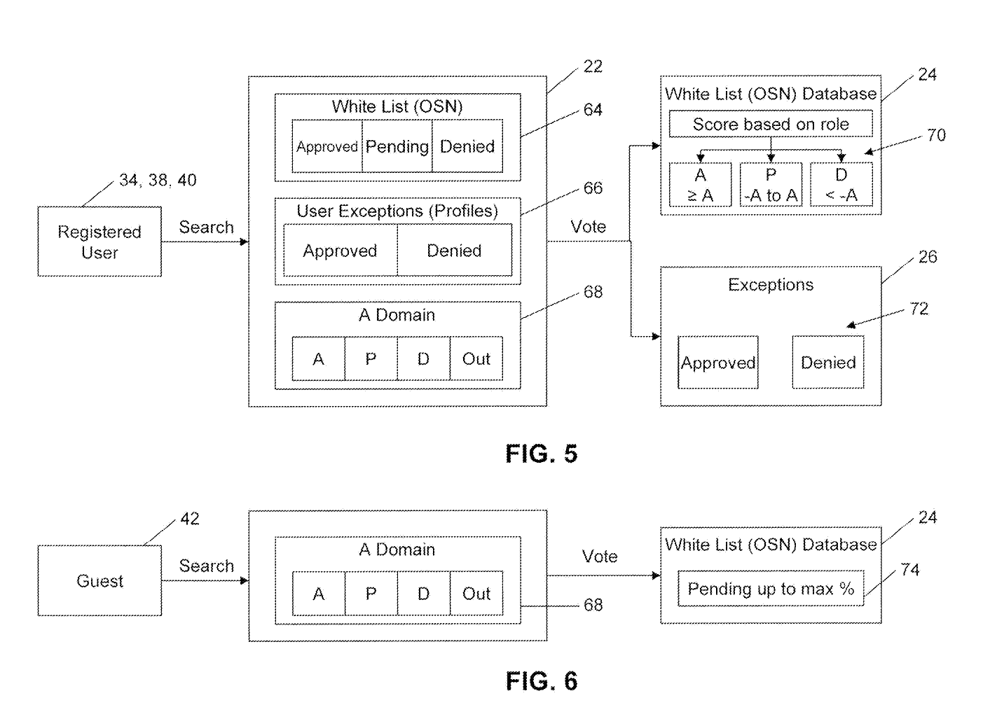

FIG. 5 illustrates a flow chart for an example search query made by a registered user 34, 38, 40 to show how the voting system 22 affects a content 12 within a white list 24. The voting system 22 enables white listed results 64, user exception results 66, and other domain results 68 to be returned. For white list results 64, the status can be approved, denied, or pending. For user exception results 66 the content 12 is either approved or denied. Other domains and their associated results 68 may be approved, pending, denied, or out of the subnet. In this way, if a domain is not within a particular subnet defined by a white list 24, it is marked “out of subnet” to track which domains have not been voted on but have been added to the system 10 and are not yet pending. The results 64, 66, 68 that are provided to the user performing the search enable the user to vote, which then can update the score to an existing white list 24 at 70, or modify the exceptions 26 at 72. It can be appreciated that the other domain results 68 can be added to a white list 24 through this process, or can be added to the exceptions 26 by applying a vote. The search results 64, 66, 68 enables changes to be made to the status of content 12, which is then reflected in changes to the white list database 24 and/or exceptions database 25.

FIG. 6 illustrates a search that may be performed by a guest 42. The guest 42 is able to perform a search in order to return other domain results 68 and by voting on the content in those results. The white list 24 can be updated at 74, e.g. to add the “pending” status to a particular domain to be added to the white list 24. In this example, “A domain” represents any content 12 that, if added to the system 10, would be added to the “out” status. Based on voting, the content 12 in the “out” status may then enter the pending, approved, or denied statuses. This allows the voting system 22 to be applied to any public domain on any subnet.

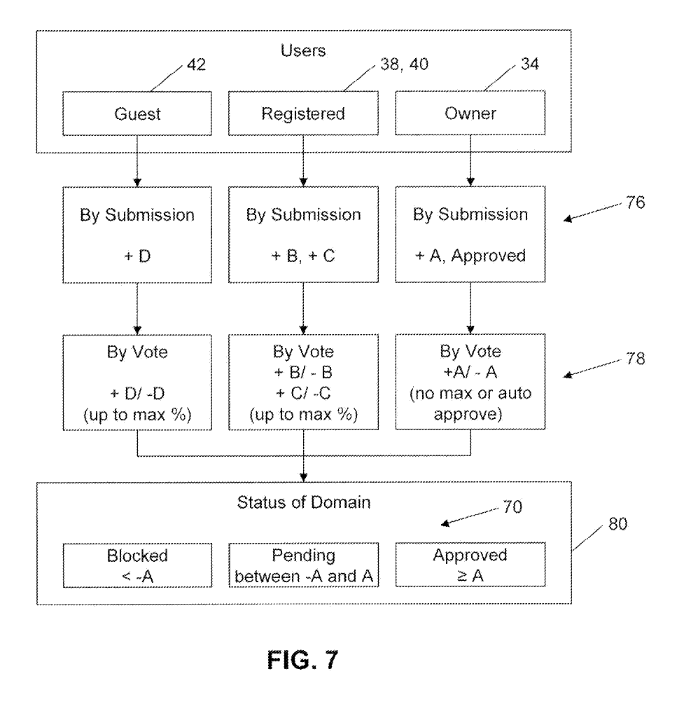

The voting scheme is further illustrated in FIG. 7. In FIG. 7 the guests 42, registered users 38, 40, and owner 34 user types are shown at the top of the flow chart. By submitting content 12 to be added to a white list 24 at 76, the respective increment value is added. If the user is instead voting for content 12 that has already been submitted at 78, the corresponding increment or decrement value is added to or subtracted from the current score (assuming the maximum contribution has not been exceeded) and the status of the domain (content 12) is updated at 80.

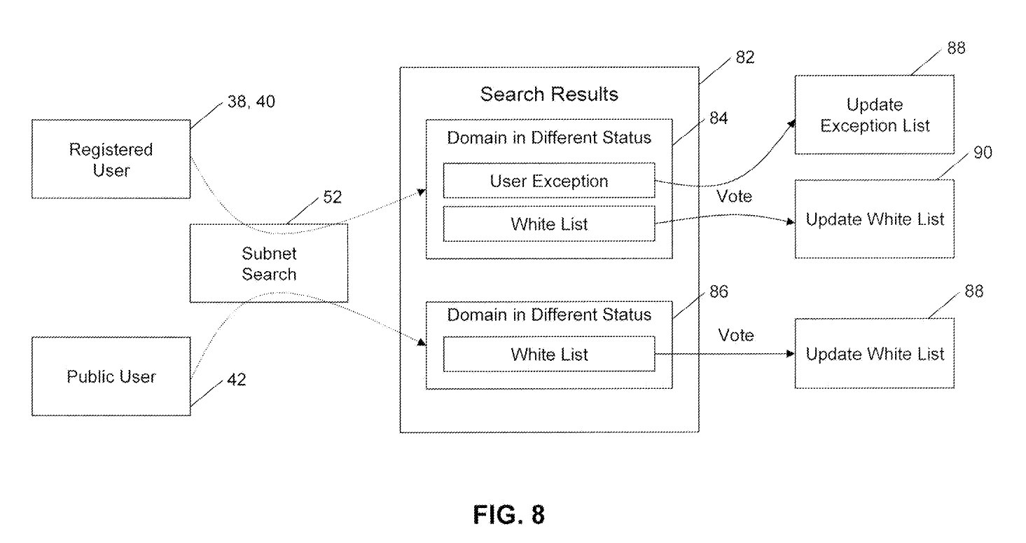

FIG. 8 shows the flow of data during a search within a white list 24. The registered users 38, 40 can perform a subnet search at 52 and the search results 82 returns a domain in a different status (e.g. approved, pending, denied, out). This allows the registered users 38, 40 to add a domain to their user profile 26 as an exception or to vote on a domain to add it to a white list 24. The exception list may then be updated at 88 and/or the white list database 24 updated at 90. Public users (e.g. guests 42) can also vote on search results 86 that enable them to contribute to the score of a domain for a particular white list 24. The white list 24 may then also be updated based on contributions from the public user 42 at 90.

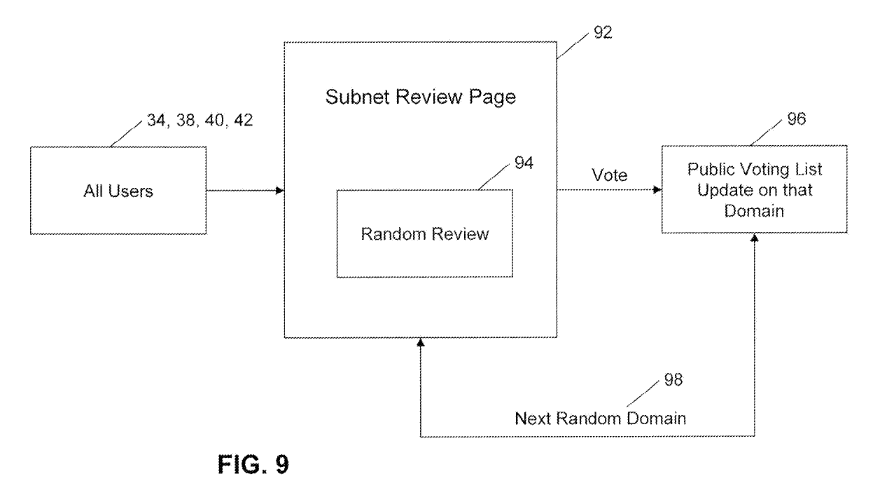

FIG. 9 illustrates a subnet review page 92 that can be used to perform a random review 94. Any user can vote on a random review 94 in order to update the voting list for that domain. The next random domain can then be reviewed at 98. The random review 94 enables websites to be submitted for review to further enhance a white list 24.

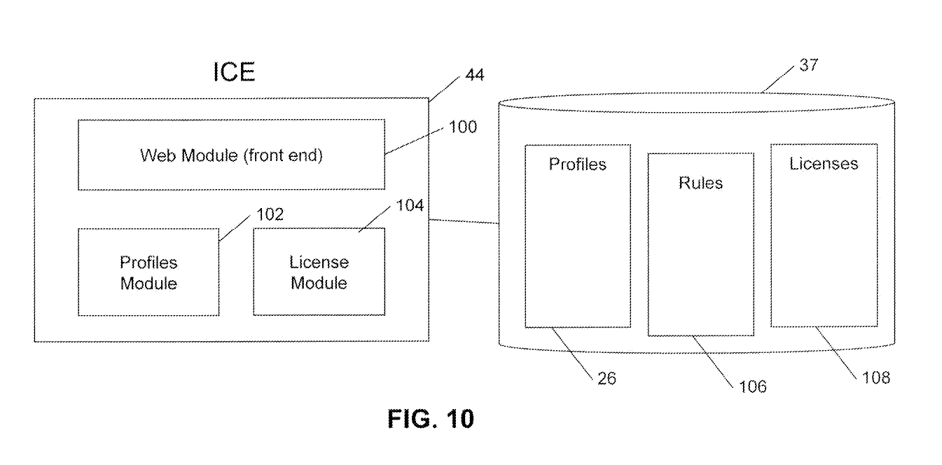

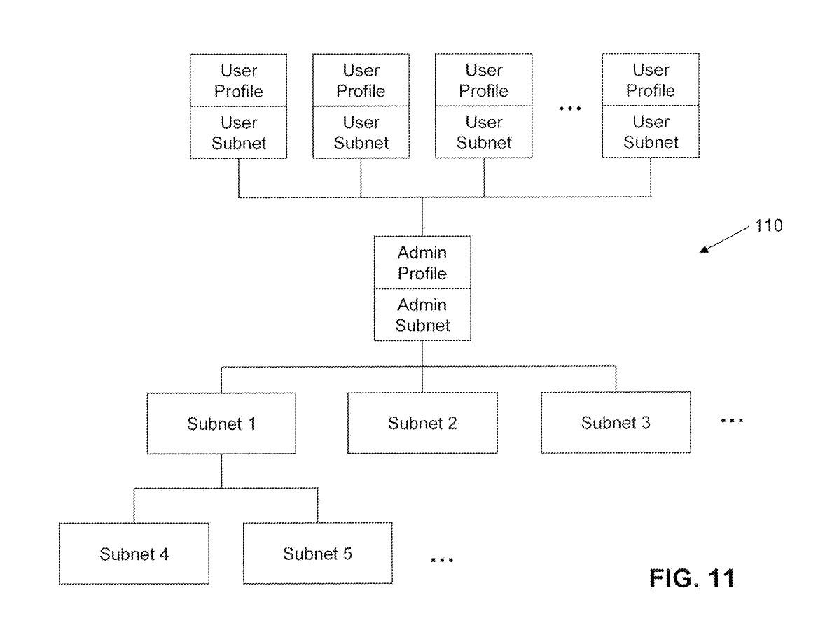

An example configuration for the intermediary 44 is shown in FIG. 10. The intermediary 44 has a web module 100 that provides a front end for users and administrators to configure users profiles 26 via a profiles module 102 and to purchase, renew or modify licenses 108 via a license module 104. The profiles 26 enable different users 50 to have exceptions 25 defined for their profile and define other rules such as how many and which white lists 24 a particular user 50 can access. The intermediary 44 there controls use of a white list 24 according to licences granted on a per-user basis. The rules 106 may represent any other feature that can be relied on to control use of the white lists 24 for various users 50. FIG. 11 illustrates a hierarchy that enables a user to search within various subnets. A user profile 26 can define which licences 108 apply to them. An admin profile and admin subnet can then control the licenses that govern the user's access to the various subnets under those licenses. The admin profile and admin subnet can be used to control the addition or removal of users 50 to the admin profile which in turn enables those users 50 to apply their profiles to the subnets allowed under the licenses granted to the admin.

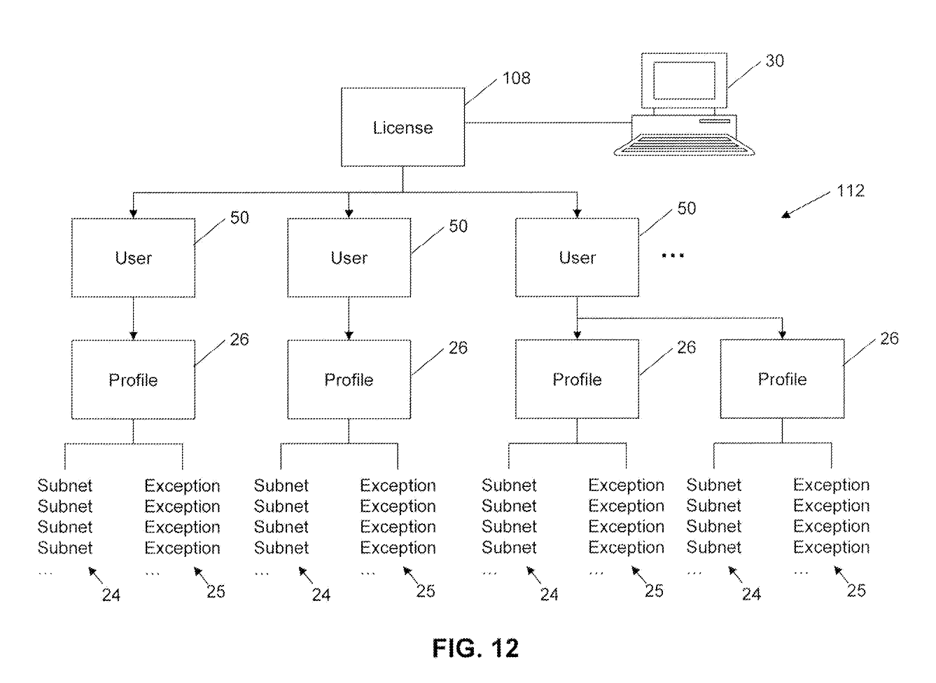

FIG. 12 illustrates an example license structure. In this example, a PC 30 has associated therewith, a license 108. The license 108 is associated with a number of users 50, each of which has a profile 26. The profiles define which subnets or white lists 24 are available to that user and the exceptions 25 that apply. A user 50 can have more than one profile 26 as shown. It can therefore be seen that the licenses 108 controlled through the intermediary 44 enable the PC 30 to control the content 12 that is delivered to various users 50 according to what is defined as being acceptable for that user.

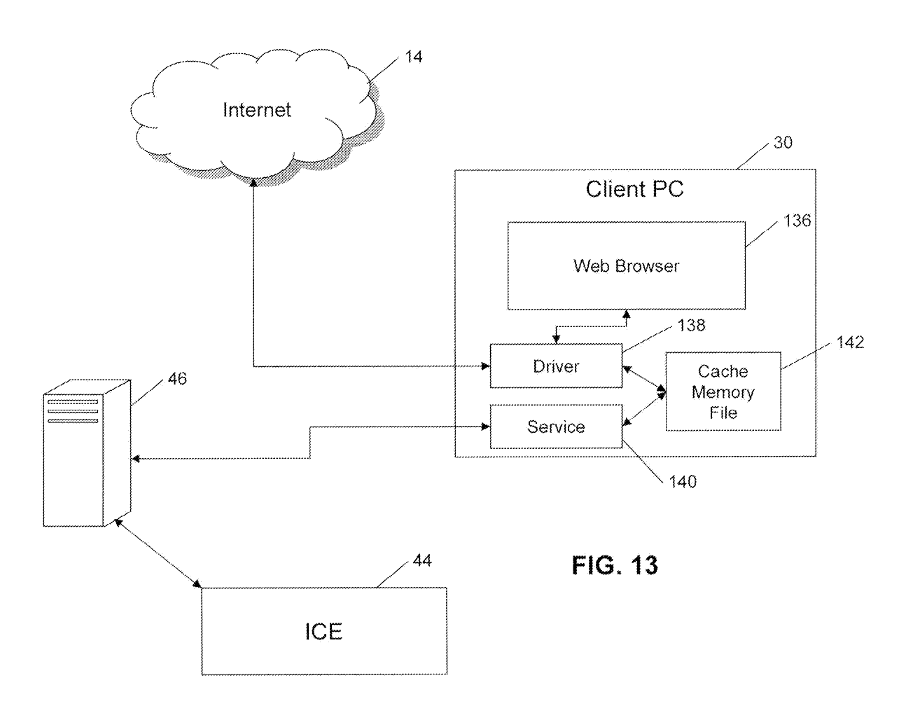

FIG. 13 illustrates an example configuration for a client service 140 to communicate with the intermediary 44 via the sync server 46. The PC 30 includes software for a web browser 136, a service 138, memory 142, and the client service 140. The web browser 136 (e.g. Internet Explorer™, Firefox™, etc.) is run by a service 138 that is connected to the Internet 14. The service 138 is also in communication with the memory 142, whereby the memory 142 stores information about the user's white lists, licenses to white lists and exceptions 25, as described above. Based on such information, the service 138 determines which websites can or cannot be accessed and displayed on the web browser 136. The client service 140 is also in communication with the memory 142 to determine the status of the white list or subnet licensing information (e.g. the time the information on memory 142 was last updated). The client service 140 is also in communication with the sync server 46, and the sync server 46 is in communication with the intermediary 44.

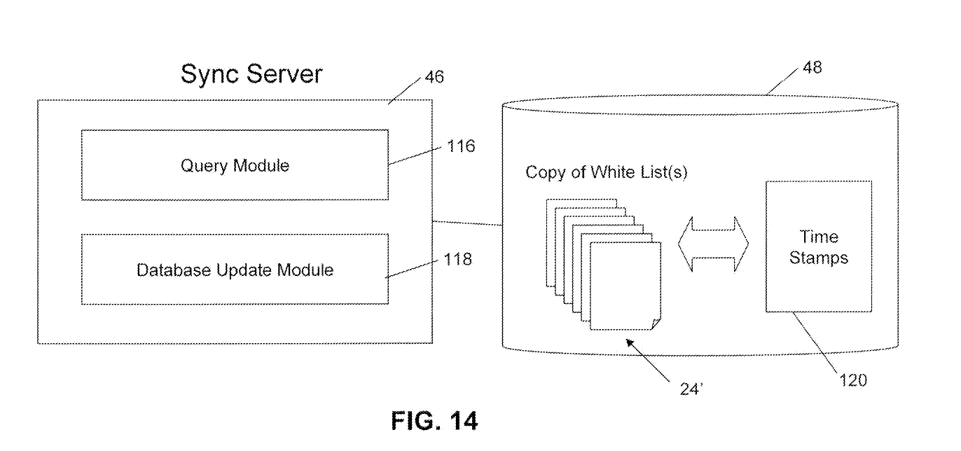

FIG. 14 illustrates an example configuration for the sync server 46. The sync server 46 comprises a query module 116 to enable queries to be performed to determine if content 12 requested by a user 50 should be allowed or blocked. The sync server 46 also has an update module 118 for determining if its local copy of the white lists 24 should be updated. To facilitate such updates, time stamps 120 that correspond to the last time each white list 24 was updated can be stored in the database 48.

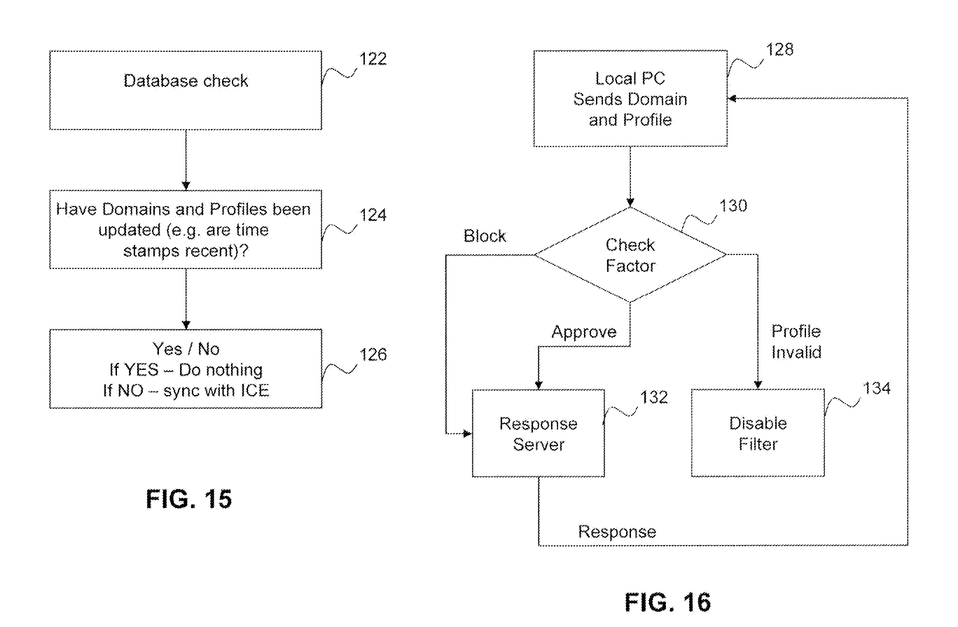

FIG. 15 illustrates example computer executable instructions that allows the sync server 46 to update a copy of a white list. At block 122, the sync server 46 checks the status of the database 28 holding the copy of the white lists. For example, the sync server 46 determines whether or not the database 48 has been updated recently. The sync server 46 compares the time stamp 120 of the most recent copy of the white list on the database 48 with the time of the most recent change to the white list 58, which is managed by the OSN 32 (block 124). If the time of the most recent change to the white list 58 is more current or recent than the time on the most recent time stamp 120, which mark when the copy of the white list was last updated in the database 48, then the sync server 46 will initiate a synchronization between the local white list in database 48 and the white lists in database 58 (block 126). In particular, the sync server 46 will obtain the most updated changes to the domains and profiles of the user from the intermediary 44. If, however, the time stamp of the last update to the database 48 is more recent than the last change to the database 58, then no action is taken. The updates that are local to the sync server 46 are then propagated or transmitted to the connected PCs 30 through the client service 140.

It can be appreciated that the method described with respect to FIG. 15 also applies to updating the white lists or subnet licenses on the memory 142 of the PC 30. There may be time tags associates with the updates to the white lists or subnet licenses on the memory 142. The client server 140, via the sync server 46, can synchronize the changes on the database 48 with the white lists or subnet licenses on the memory 142.

Turning to FIG. 16, a flow diagram is provided to illustrate example computer executable instructions executed by the sync server 46 for blocking or approving a web page request and determining the validity of a licence to access a subnet. In particular, a user on a PC 30 may request to access a certain internet web site, e.g. domain, and the request from the PC 30 may be sent to the sync server 46 for processing. At block 128, the local PC 30 sends the request for the domain and its profile information to the sync server 46. At block 130, the sync server 46 receives the domain and the user's profile information, and then determines whether or not the profile is approved or invalid or blocked (e.g. denied). If the profile is invalid, the filter is disabled (block 134). If the profile is approved, then the sync server 46 provides a response to the PC 30, regarding whether or not the request is allowed to be accessed (block 132). If the profile is blocked (e.g. denied), then the sync server 46 also provides a response to the PC 30. For example, if blocked, the sync server 46 provides a response that based on the profile, access is denied.

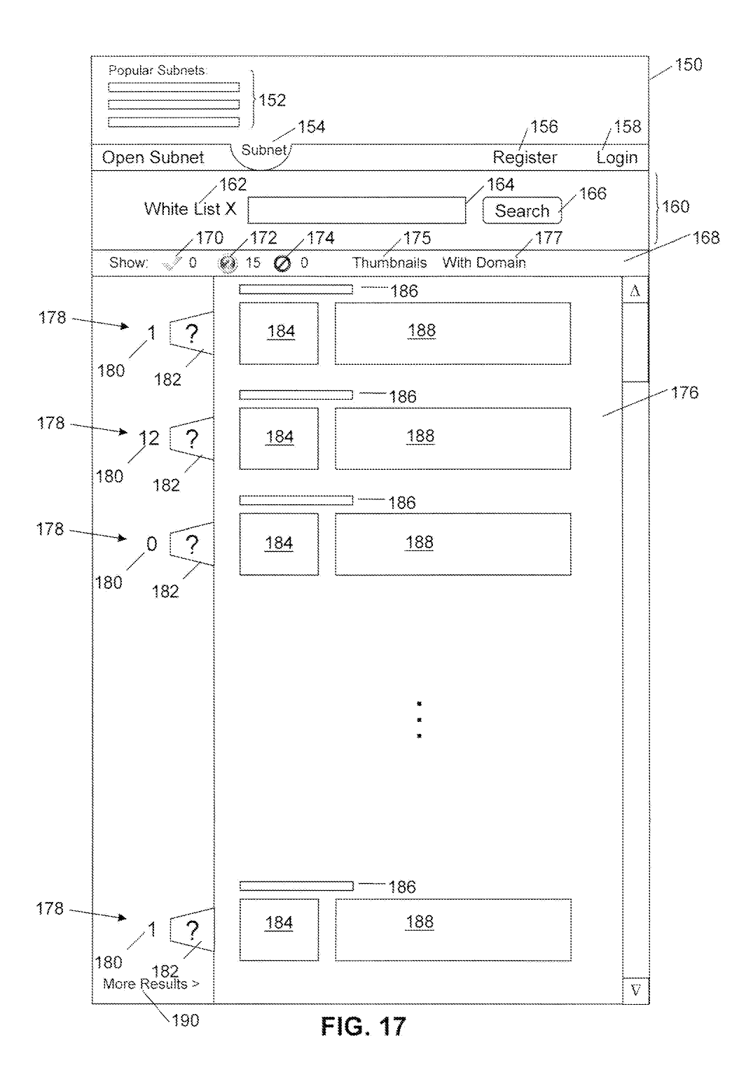

Turning to FIG. 17, a screen shot 150 of an example GUI for the search engine 52 is provided. In the upper portion of the screen 150, there may be a list of popular subnets 152. In one embodiment the list 152 shows subnets that have been licensed to the user. A user can select or click on different subnets from the list 152 to search for information within the subnet. A particular subnet 154 may be selected and its related activities and information is shown in the body of the screen 150. The screen 150 also includes a register 156 button, e.g. for registering as a new user, and a login button 158, e.g. for logging in as an existing user. A search bar 160 allows a user to input text into the search field 164 to search for websites within the white lists of the selected subnet 154. This is indicated by the marking “White List” 162. Selecting or clicking on the search button 166 initiates the search of the white lists based on the provided search parameters. A results summary bar 168 allows the user to quickly view the number of approved domains, the number of pending domains, and the number of rejected domains; these are shown by the icons 170, 172, and 174 respectively. Buttons or interfaces 175 and 177 allow the user to control whether thumbnails of the websites and the full domain address are shown, respectively. One or more of the search results 178, e.g. websites or domains, are listed in the main body 176 of the screen 150. Each search result 178 shows the number of votes, or the voting score 180 and a status symbol 182 to indicating whether the domain is approved, pending or rejected. In this case, all the domains shown are pending, as indicated by the question mark. The search result 178 also includes the name of the website or domain 186, a thumbnail 184 illustrating a portion of the website or domain, and a description 188 of the website or domain. At the bottom of the screen 150, there may also be another interface or button 190 that the user can click or activate to view more results.

It can be appreciated that the modular configuration of the subnets and the characteristics of the voting structure that allow for a subnet to quickly evolve allows for the creation and maintenance of many high quality subnets. As more users or voters provide their opinion on whether to approve or deny a website or domain, typically, the quality and relevance of the domains within a website increases. In an organization example, such as a school, one school may create and maintain a number of subnets related to academic subjects (e.g. a “history” subnet, a “math” subnet, a “science” subnet, etc.), and the subnets may be used to control students' access to web content. If the school's subnet is perceived to be of high quality, another school may desire to license the school's subnets, which is made possible by the modular configuration and associated licensing structure of the subnets.

In general, a system and a method are provided for generating a list of domains and using the list of domains to control access to web content. It includes providing an open subnet server to receive one or more proposed web pages to be added to a white list on the list of domains, as well to receive one or more votes from one or more users whether or not to add one or more of the web pages to the white list; and providing one or more licences to permit access to the white list.

In another aspect, the one or more users include registered and unregistered users. In another aspect, a registered user has a profile that includes one or more exception web pages that are blocked from the white list, but deemed acceptable to the registered user. In another aspect, a registered user has a profile that includes one or more exception web pages that are approved on the white list, but deemed unacceptable to the registered user. In another aspect, voting for the one or more web pages further comprises calculating a total voting score from the one or more votes from the one or more users. In another aspect, each of the one or more votes has an increment or a decrement value. In another aspect, the one or more users are categorized into user types, and the increment or the decrement value varies by each user type. In another aspect, votes from at least one of the user types has a maximum contribution to the total voting score. In another aspect, the user types comprise one or more guests, one or more members, and one or more owners, with the owners having the highest increment or decrement value and with the guests having the lowest increment or decrement value. In another aspect, the one or more owners have veto power to approve or deny the one or more web pages being added to the white list. In another aspect, based on the total voting score, the one or more proposed web pages can be approved, denied, or pending. In another aspect, it further comprises providing a sync server connected to the open subnet server, the sync server obtaining a copy of the white list and, based on an end user's license to the list of domains, providing to the end user access to web pages on the white list. In another aspect, it further comprises providing a search engine connected to the open subnet server for the end user to search the web pages on the white list.

Although the above principles have been described with reference to certain specific embodiments, various modifications thereof will be apparent to those skilled in the art without departing from the scope of the claims appended hereto.

1. A method for generating a list of domains and using the list of domains to control access to web content, the method comprising:
providing an open subnet server to receive one or more proposed web pages to be added to a white list on the list of domains, as well to receive one or more votes from one or more users whether or not to add one or more of the web pages to the white list; and
providing one or more licences to permit access to the white list.

2. The method of claim 1 wherein the one or more users include registered and unregistered users.

3. The method of claim 2 wherein a registered user has a profile that includes one or more exception web pages that are blocked from the white list, but deemed acceptable to the registered user.

4. The method of claim 1 wherein voting for the one or more web pages further comprises calculating a total voting score from the one or more votes from the one or more users.

5. The method of claim 4 wherein each of the one or more votes has an increment or a decrement value.

6. The method of claim 5 wherein the one or more users are categorized into user types, and the increment or the decrement value varies by each user type.

7. The method of claim 6 wherein votes from at least one of the user types has a maximum contribution to the total voting score.

8. The method of claim 6 wherein the user types comprise one or more guests, one or more members, and, one or more owners, with the owners having the highest increment or decrement value and with the guests having the lowest increment or decrement value.

9. The method of claim 8 wherein the one or more owners have veto power to approve or-deny the one or more web pages being added to the white list.

10. The method of claim 4 wherein, based on the total voting score, the one or more proposed web pages can be approved, denied, or pending.

11. The method of claim 1 further comprising providing a sync server connected to the open subnet server, the sync server obtaining a copy of the white list and, based on an end user's license to the list of domains, providing to the end user access to web pages on the white list.

12. The method of claim 11 further comprising providing a search engine connected to the open subnet server for the end user to search the web pages on the white list.

13. A system for generating a list of domains and using the list of domains to control access to web content, the system comprising:
an open subnet server configured to receive one or more proposed web pages to be added to a white list on the list of domains, as well to receive one or more votes from one or more users whether or not to add one or more of the web pages to the white list; and
one or more licences to permit access to the white list.

14. The system of claim 13 wherein the one or more users include registered and unregistered users.

15. The system of claim 13 wherein a registered user has a profile that includes one or more exception web pages that are blocked from the white list, but deemed acceptable to the registered user.

16. The system of claim 13 wherein the open subnet server is further configured to calculate a total voting score from the one or more votes from the one or more users, the total voting score used to determine whether or not to add the one or more web pages to the white list.

17. The system of claim 16 wherein each of the one or more votes has an increment or a decrement value.

18. The system of claim 17 wherein the one or more users are categorized into user types, and the increment or the decrement value varies by each user type.

19. The system of claim 18 wherein votes from at least one of the user types has a maximum contribution to the total voting score.

20. The method of claim 18 wherein the user types comprise one or more guests, one or more members, and one or more owners, with the owners having the highest increment or decrement value and with the guests having the lowest increment or decrement value.

21. The system of claim 19 wherein the one or more owners have veto power to approve or deny the one or more web pages being added to the white list.

22. The system of claim 16 wherein, based on the total voting score, the one or more proposed web pages can be approved, denied, or pending.

23. The system of claim 13 further comprising a sync server connected to the open subnet server, the sync server obtaining a copy of the white list and, based on an end user's license to the list of domains, providing to the end user access to web pages on the white list.

24. The system of claim 23 further comprising a search engine connected to the open subnet server for the end user to search the web pages on the white list.
